(19) United States
(12) Patent Application Publication
(10) Pub. No.: US 2005/0204782 A1
(43) Pub. Date: Sep. 22, 2005

(54) Plypropylene fabric and its use in the personal care field

(76) Inventor: Luigi Pezzoli, Cene (IT)

Correspondence Address: NIXON & VANDERHYE, PC, 901 NORTH GLEBE ROAD, 11TH FLOOR, ARLINGTON, VA, 22203, US

(21) Appl. No.: 10/516,011

(22) PCT Filed: May 31, 2002
(86) PCT No.: PCT/IT02/00356

§ 371 Date: May 9, 2005

(51) Int. Cl. B32B 33/00; D05C 17/00; B05D 1/14

(52) U.S. Cl. 66/202; 428/92; 428/99; 428/97

(57) ABSTRACT

A fabric based on raw or pulp-colored polypropylene intended in particular for use as a “mechanical fastener” of the hook and loop type and utilization of said fabric in health and personal care sector.

### OBJECT OF THE INVENTION

The present invention relates to a fabric from polypropylene, either raw or pulp-colored, intended in particular for the mechanical fastening of the hook and loop type, and use thereof in several sectors and in particular in the personal care one.

### KNOWN ART

As is known, polymers of synthetic origin that are especially utilized in the production of yarns and therefore of fabrics suitable for the most different uses, comprise, for instance, polyamide, polyester and polypropylene. These polymers are treated according to traditional techniques and then utilised, either alone or coupled with each other or to other fabrics also, for instance, of natural origin, for the realization of various kinds of fabrics intended for the most different sectors, from sports- and casual clothing up to the industrial, health and personal care sectors, cars, shoes, furnishings, abrasive articles, and the like. Polypropylene has always captured a great attention because of two main reasons: first of all, it is rather “economical” with respect to other polymers, for instance the aforementioned ones, and besides it is entirely recyclable and non toxic, allowing therefore to realize products having a very reduced impact on environment.

There are at present on the market polypropylene yarns having a yarn count in excess of 70 deniers which have however a limited application field and are used for the realization of products belonging to very limited sectors.

The process commonly utilized today for the realization of polypropylene yarns requires many distinct steps that involve such a cost of manpower as to render the obtained product very expensive, canceling out therefore the advantage of the low cost of the starting products.

One of the main problem arises from the fact that the processes for the realization of polypropylene yarns are very complex, as they comprise many separate working steps, and are often very long, causing thereby the production of polypropylene yarns to be very expensive. In practice, even though the raw material (polymer/fiber) is rather advantageous from the economic point of view, process difficulties and working times render the spun and finished product very expensive and not convenient from the commercial point of view.

### OBJECTS OF THE INVENTION

Object of the present invention is to provide polypropylene fabrics intended, for instance, for mechanical fastening systems of the hook and loop type, and that are applicable to products of different fields, and in particular the health and personal care field, being essentially non toxic and entirely recyclable.

Another object of the present invention is to provide a polypropylene fabric having a low count of yarns and weight, such as not to loose the economic advantages ensuing from polypropylene low starting cost.

A further object of the present invention is to provide a fastening system of the hook and loop type realized with a polypropylene fabric coupleable by heat and ultrasounds and needing no glues/resins that jeopardize the natural non toxicity and recyclable nature of said product.

Still a further object of the invention is to provide a process for the preparation of a fabric from polypropylene that involves only a few steps, that is rapid and that supplies a product advantageous from the economic point of view.

### DESCRIPTION

These and still further objects and related advantages that will be better stressed by the following description are achieved by a polypropylene-based fabric having a weight comprised between 10 and 300 g/m², suitable to engage with hook elements of another fabric/component, and made up by yarns that come in the form of needle loops (eyelets), that comprise at least a base yarn and at least a knitted fabric that protrudes towards the outside of at least a side of said fabric.

Always according to the present invention, said polypropylene-based fabric has a weight comprised between 10 and 150 g/m², preferably between 10 and 100 g/m². It was found that it is possible to advantageously realize polypropylene-based fabrics according to the invention having a weight comprised between 10 and 50 g/m² that have all the advantages that will be described below.

According to the present invention, said polypropylene-based fabric comprises at least a continuous and/or discontinuous yarn and can be worked on ladder-proof, weft insertion, rachel, stitch-bonding, circular knitting, chain-weft looms.

More particularly, the polypropylene fabric may be based on a continuous mono-filament and/or a multi-filament yarn.

The polypropylene fabric according to the invention is entirely recyclable, does not affect environment, and provides big advantages with respect to compatibility with other polypropylene components. In particular, a great advantage arises from the fact that the fabric according to the present invention may be ultrasound and/or heat coupled, without having to use glues or resins that would jeopardize its natural non toxicity and recycling possibility. As is known, polypropylene is actually today the fittest product to be used and widespread in many sectors, for instance, to realize fabrics for use in abrasive, car, furniture, clothing, footwear, electronic, geotextile, and in particular, personal care sectors.

The so realized polypropylene fabric keeps unaltered the economic characteristics of the starting product employed, and conquers a market space previously non accessible because of the high working costs of the processes according to the known art. The advantages obtained from a low cost polypropylene fabric are numberless, and only some of them will be stressed hereunder:
as polypropylene is a 100% recyclable product, the products that can be realized have no ecological and environmental impact at all and may be advantageously employed in many applications, as for instance the personal care sector;
polypropylene is a product having high hydrophobia characteristics and is therefore suitable for all applications wherein avoiding the formation of mildew, the proliferation of micro-organisms and bacteria of various type is of the essential. In particular, polypropylene is suitable for use in personal care field wherein its marked hydrophobia, together with its entire recycling possibility and tendential non toxicity, cause it to be very interesting and compatible for subsequent operations;
polypropylene is a low melting point product and therefore suitable for all types of ultrasound and/or heat coupling, without having to use resins and glues;
besides, with respect to some synthetic products of the known art, polypropylene is characterized by a specific weight lower by about ⅓ compared, for instance, to polyamide, and therefore, the diameter of the yarn being equal, the product realized with polypropylene is much lighter and has a lower yarn count with respect to a like product made from polyamide.

Therefore, according to the present invention, it is possible to realize a polypropylene fabric having a yarn count lower than or equal to 150 deniers, that is advantageous from the economic point of view and that is therefore of commercial interest.

According to the present invention, it is possible to realize fabrics having various characteristics. In particular, it is possible to utilize a continuous mono-filament or multi-filament yarn from polypropylene, and to obtain a fabric of the so-called terry type, or it is possible to realize a fabric of the raised type, using for the weaving two-, three-, four-comb looms (multi-bar) of the ladder-proof type. In this case, if one starts from a 100% polypropylene yarn, 100% recyclable fabrics are obtained that show many advantages, especially if they can be produced and marketed to'costs contained and competitive with respect to equivalent fabrics realized from non recyclable material. Always according to the present invention, it is possible to realize a fabric wherein the continuous (mono-filament and/or multi-filament) polypropylene yarn is meshed with a variable percentage of discontinuous polypropylene yarn. Also in this case, the fabric that is obtained, being entirely made from polypropylene, is 100% recyclable and shows the aforesaid advantages.

Further, according to the invention, it is possible to realize a fabric that comprises a variable percentage of continuous (mono-filament and/or multi-filament) polypropylene yarn associated to a variable percentage of yarn compatible but different from polypropylene. In this case, and depending on the material utilized, the fabric obtained will be no longer 100% recyclable, but has however other interesting characteristics arising also from the characteristics of the material selected. For instance, the compatible material may be advantageously selected from polyamide and/or polyester.

By way of non limiting example of the present invention, the attached Figures are described, and in particular:

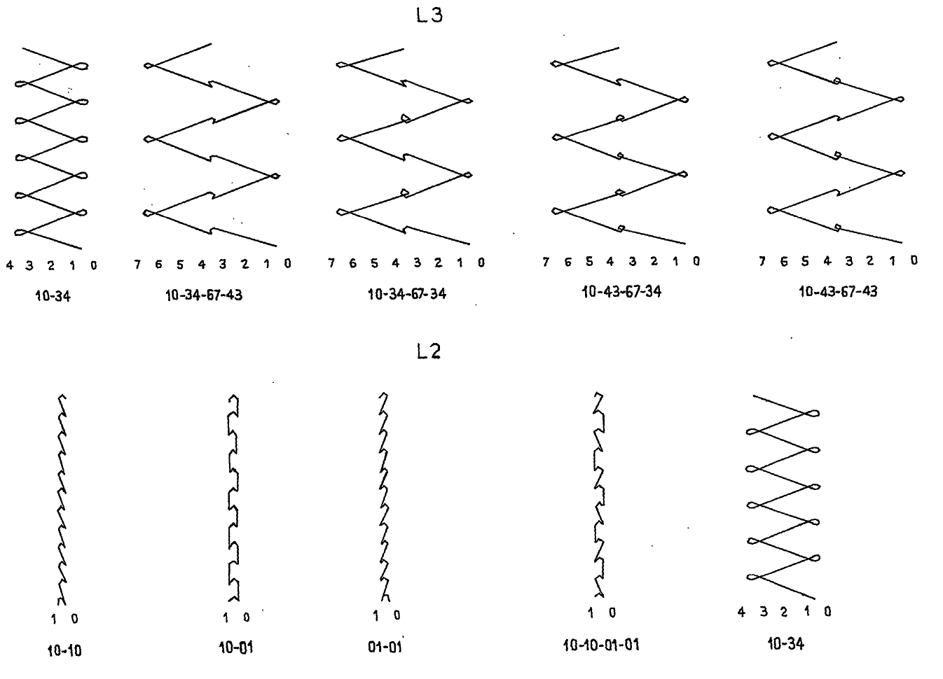

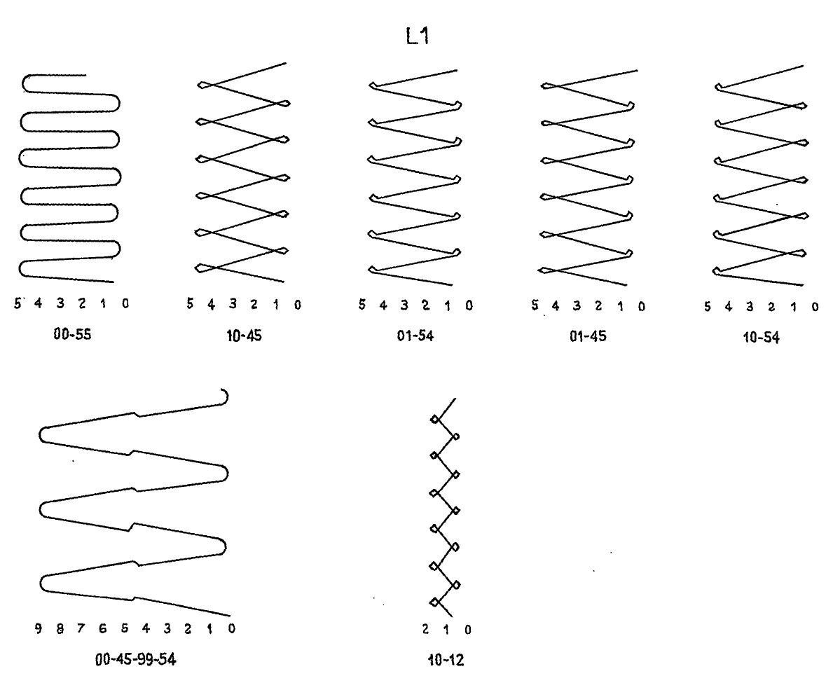

FIGS. 1 and 2 show the construction scheme of a polypropylene-based fabric according to the present invention.

According to said figures, one observes that they show some of the possible constructions realizable according to the present invention. In particular, L₁, L₂ and L₃ indicate the movement of the various combs operating on the looms employed for the realization of the above described and still other fabrics. For instance, to realize a fabric of the non-raised type, there may be advantageously utilized three-comb looms and therefore all the combinations possible between L₁, L₂ and L₃ lead to the formation of fabrics having different characteristics but provided all with the advantages previously described. Should one wish to realize a fabric of the raised type, there may be utilized for instance two-comb looms, and as a consequence all the combinations between L₁ and L₂ will be possible. In any case, both types of looms may be utilized for the realization of the above described fabrics.

Always according to the invention and as said above, the polypropylene yard employed may be of the continuous filament or staple type with a yarn count comprised between NE 16/1 and NE 100/1. Two- or three-combs (multi-bar) knitting or rachel looms may be utilized according to the fabric type to be obtained and also weft insertion, rachel, stitch-bonding, circular knitting, chain-weft looms. The fabric according to the invention may have a fineness equal to or lower than 40.

Some examples of practical realization of fabrics realized according to the present invention will be now reported by way of non limiting explanation of the present invention.

### EXAMPLE 1

“Raised” Fabric

L₁ comb weave 10-12
L₂ comb weave 10-34

### EXAMPLE 2

“Terry” Fabric

L₁ comb weave 00-55
L₂ comb weave 10-01
L₃ comb weave 10-43-67-34

### EXAMPLE 3

“Terry” Fabric

L₁ comb weave 10-45
L₂ comb weave 10-01
L₃ comb weave 10-34-67-43

The fabric according to the invention may be submitted to serial raising and cutting operations, according to the intended use thereof. In particular, as said above, the polypropylene-based fabric is advantageously employed for the realization of mechanical fastening systems especially intended for, among other sectors, the personal care sector. These products are of great interest, especially when they are made entirely from polypropylene, and therefore entirely recyclable, coupleable by ultrasounds and/or heat, without having to use glues/resins that jeopardize the natural non-toxicity and recycling possibility of said products.

1. A polypropylene-based fabric having a weight comprised between 10 and 300 g/m², suitable to engage with hook elements of another fabric/component, and formed by yarns that come in the form of “needle loops” (eyelets) that comprise at least a base yarn and at least a knitted yarn that protrudes towards the outside of at least a side of said fabric.

2. The fabric according to claim 1, characterized in that its weight ranges from IO to 150 g/m².

3. The fabric according to claim 1, characterized in that its weight ranges from 10 to 100 g/m².

4. The fabric according to claim 1, characterized in that its weight ranges from 10 to 50 g/m².

5. The fabric according to claim 1, characterized in that it comprises at least a continuous and/or discontinuous raw and/or pulp colored yarn.

6. The fabric according to claim 1, characterized in that it is worked on ladder-proof, weft insertion, rachel, stitch-bonding, circular knitting, chain-weft looms.

7. The fabric according to claim 1, characterized in that said yarn is a continuous mono-filament yarn.

8. The fabric according to claim 1, characterized in that said yarn is a continuous multi-filament yarn.

9. The fabric according to claim 1, characterized in that it is submitted to raising and cutting operations.

10. The fabric according to claim 1, characterized in that it is meshed with a variable percentage of discontinuous polypropylene yarn.

11. The fabric according to claim 1, characterized in that it is meshed according to a terry (non raised) configuration.

12. The fabric according to claim 1, characterized in that said knitted yarn is meshed according to a “velvety” (raised) configuration.

13. The fabric according to claim 11, characterized in that it has the following construction:
Li comb weave 00-55
L₂ comb weave 10-01
L₃ comb weave 10-43-67-34

14. The fabric according to claim 11, characterized in that it has the following construction:
L₁ comb weave 10-45
L₂ comb weave 10-01
L₃ comb weave 10-34-67-43

15. The fabric according to claim 12, characterized in that it has the following construction:
L₁ comb weave 10-12
L₂ comb weave 10-34

16. The fabric according to claim 1, characterized in that it has a yarn count lower than or equal to 150 deniers.

17. The fabric according to claim 1, characterized in that it has a yarn count comprised between NE 5/1 and NE 100/1.

18. The fabric according to claim 1, characterized in that it is realized in association with a variable percentage of yarn of a material compatible with but different from polypropylene.

19. The fabric according to claim 18, characterized in that said yarn from compatible material is a yarn from polyamide and/or polyester.

20. The fabric according to claim 1, characterized in that it has a fineness equal to or lower than 40.

21. The fabric according to claim 1, characterized in that it is heat-coupled.

22. The fabric according to claim 1, characterized in that it is ultrasound-coupled.

23. Use of the fabric according to claim 1, for the realization of mechanical fastening systems.

24. Use of the fabric according to claim 23, characterized in that said mechanical fastening systems are of the hook and loop type.

25. Systems for the mechanical fastening from polypropylene fabric according to claim 1.

26. Use of the mechanical fastening systems of claim 25 in the personal care sector.

27. Method for the realization of mechanical fastening systems for use in the personal care sector.

28. Method for the realization of mechanical fastening systems for use in the abrasive and car sectors, furnishings, clothing, footwear, electronic, geotextile sectors.
